(19) United States
(12) Patent Application Publication
(10) Pub. No.: US 2009/0067783 A1
(43) Pub. Date: Mar. 12, 2009

(54) METHOD OF TUNING AN ADJUSTABLE DISPERSION COMPENSATOR

(75) Inventors: Stephen Michael WEBB, Gravesend (GB); John ELLISON, Colchester (GB)

Correspondence Address: Workman Nydegger;1000 Eagle Gate Tower, 60 East South Temple, Salt Lake City, UT, 84111, US

(73) Assignee: AZEA NETWORKS LIMITED, Romford, Essex (GB)

(21) Appl. No.: 11/852,175

(22) Filed: Sep. 7, 2007

(51) Int. Cl. G02B 6/26

(52) U.S. Cl. 385/27

(57) ABSTRACT

In the present invention, a method of controlling a tuneable optical dispersion compensating device to act on an optical signal by automatically controlling a plurality of dispersion control settings of the device in a systematic way using feedback, thereby to adapt freely the optical group delay for the optical signal within a predetermined wavelength range including that of the optical signal.

### BACKGROUND TO THE INVENTION

Tuneable dispersion compensation may be achieved via a concatenation of optical “all-pass” filters such as Gires-Tournois Etalons, waveguide Mach Zehnder interferometers and micro-ring devices.

So called “all-pass” filters have the characteristic that they substantially pass through all input light but alter the group delay as a complex Lorentzian-like function of wavelength or optical frequency. In the case of an all-pass etalon, the strength of the response is governed by the reflectivity of the partially transmissive mirror, the other mirror being 100% reflective. The greater the reflectivity of the partial mirror the sharper the group delay response and vice versa. The coarse bulk distance between the mirrors sets the free-spectral range of the etalon—that is to say the repeat frequency of the etalon response. The fine distance between the mirrors sets the absolute frequency position and this may be tuned by very small changes in the mirror gap. Etalons are commonly fabricated via a thickness of glass block onto which the mirrors are deposited, whereby the free-spectral range is defined by the bulk thickness and the fine tuning is achieved by changing the glass temperature and relying on its thermal expansion coefficient.

An example of the optical response of a commercially available 4-stage concatenated Gires-Tournois etalon dispersion compensator is shown in FIG. 1. By arranging a number of different etalon responses in concatenation, and tuning the specific wavelength offset (etalon temperature) of each, a pseudo-linear group delay response versus optical frequency may be synthesised via the sum of each ones characteristic. Such a linear response mimics optical dispersion from transmission fibre and the slope may matched within limits by subtly spreading out or bunching up the etalon frequency offsets. Indeed, more etalons may be added or taken away (e.g. by tuning in/out of band), to achieve a flexible control of the group delay. By reversing the order of the etalons in terms of frequency offset, the sign of the optical dispersion may be inverted.

The etalon dispersion compensator can only give quasi-linear group delay over a limited wavelength range. Beyond a certain point the characteristic diverges from this linear approximation, and then it repeats the profile again at a period equal to the free-spectral range of the etalons.

Commercially available devices require complex factory calibration data, typically supplied in the form of a lookup table. The calibration data indicates each etalon temperature for each required dispersion setting. FIG. 2 is graph of dispersion against etalon temperature for the 4-stage etalon dispersion compensator of FIG. 1, illustrating different possible etalon temperatures for each required dispersion setting provided by the manufacturer.

Such a scheme only allows quantised dispersion values and is normally optimised to derive a linear group delay versus wavelength with minimum group delay ripple. Consequently, the dispersion setting is only as good as the initial calibration and a residual transmission penalty is likely unless the set-point is exactly that required. Furthermore, should the setting requirement change (e.g. cable repair), active intervention is necessary to re-tune the operation. In addition, wavelength accuracy of the transmitter with respect to the receiver is paramount to achieve a meaningful dispersion setting defined in the device calibration.

It has also been found that tuning for linear group delay with minimum group delay ripple is not necessarily the optimum operating point to achieve best transmission Q or BER. Often a residual penalty is seen when compared to idealised dispersion compensating fibre.

### SUMMARY OF THE INVENTION

In the present invention, a method of controlling a tuneable optical dispersion compensating device to act on an optical signal by automatically controlling a plurality of dispersion control settings of the device in a systematic way using feedback, thereby to adapt freely the optical group delay for the optical signal within a predetermined wavelength range including that of the optical signal. The tuneable optical dispersion compensating device may be positioned at any point with an optical transmission line, but preferably is placed within a transmitter or receiver, or both.

Preferably, the tuneable optical dispersion compensating device is a concatenated series of optical all-pass filters, more preferably etalon filters, waveguide Mach Zehnder interferometers or micro-rings.

Where etalon filters are used, preferably the dispersion control settings are the etalon temperature for each respective etalon filter. Preferably, the method includes an initial step of selecting an etalon temperature for each etalon based on a required dispersion, using standard calibration data for the device, which typically assumes a linear group delay. More complex group delay profiles are automatically discovered over time, which profiles would not be included in the standard calibration data.

Preferably, the dispersion control settings are controlled in dependence on a bit error rate (BER) measured at a receiver.

Preferably, the etalons are tuned to act over a specific wavelength range including that of the optical signal to be compensated.

The plurality of dispersion control settings may be varied sequentially or in parallel. Preferably, the method utilises a dither algorithm to adjust the dispersion control parameters. Alternatively, dispersion control settings may be adjusted in parallel by use of more sophisticated algorithms such as a “Nelder-Mead simplex” algorithm.

### BRIEF DESCRIPTION OF THE DRAWINGS

Examples of the present invention will now be described in detail with reference to the accompanying drawings, in which:

FIG. 1 shows the response of an example of a known 4-stage concatenated Gires-Tournois etalon dispersion compensator;

FIG. 2 is graph of dispersion against etalon temperature for the 4-stage etalon dispersion compensator of FIG. 1, illustrating each etalon temperature for each required dispersion setting;

FIG. 3 shows an optical transmission system employing an adaptive feedback control scheme for an etalon-based tuneable compensator in accordance with the present invention;

FIG. 4 shows a simplified example of a tuneable etalon device;

FIG. 5 illustrates how the adaptive feedback control scheme of the present invention is effective to reduce received BER over time; and,

FIG. 6 illustrates the comparative performance in terms of frequency against group delay and power for a conventional etalon dispersion compensator and the same device when controlled using the adaptive feedback control scheme of the present invention.

### DETAILED DESCRIPTION

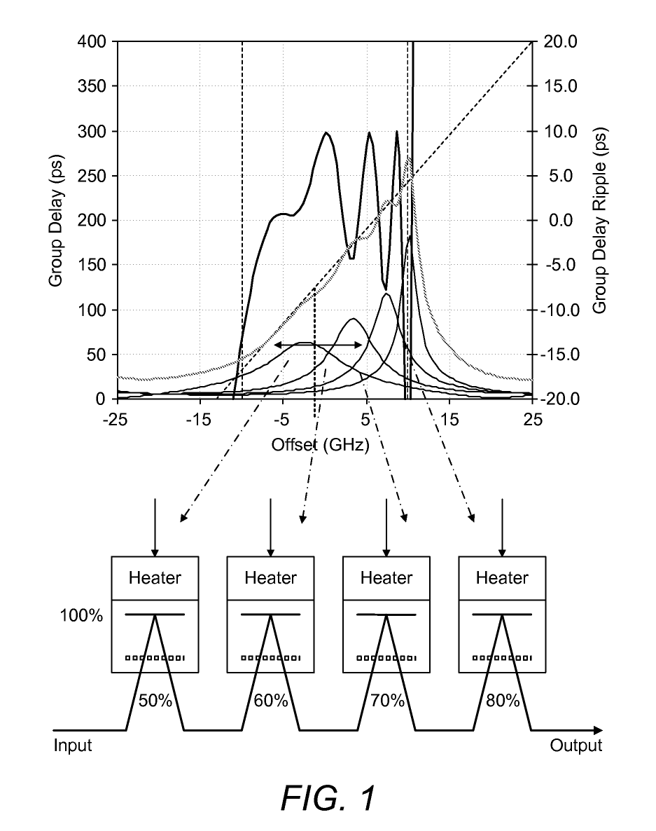

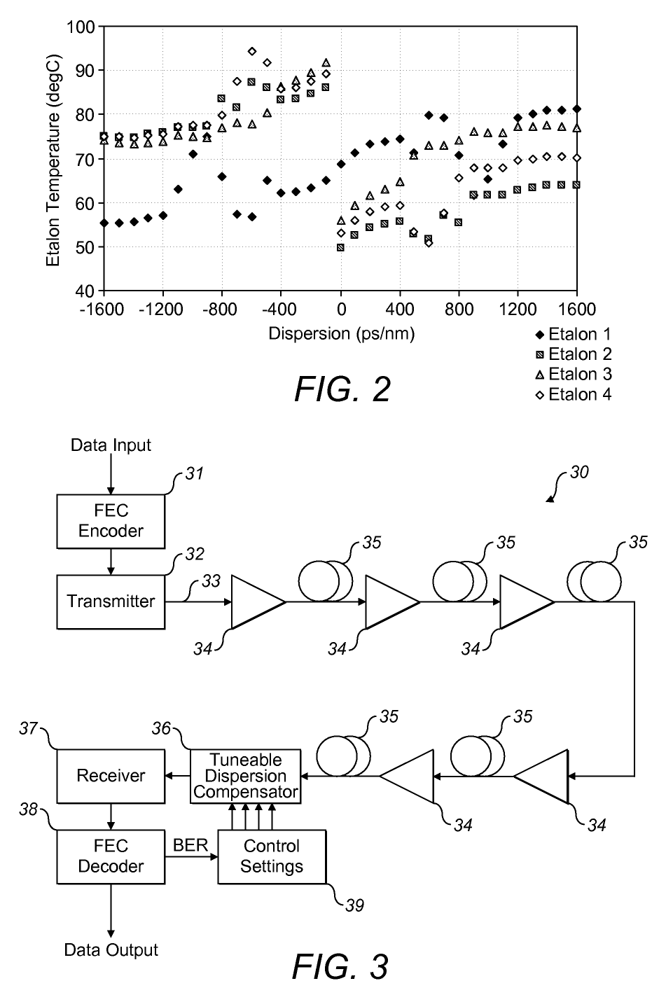

BER measurement is now generally available as a by-product of FEC in transponder design, and control loops may be designed to utilise this information in order to optimise transmission. As shown in FIG. 3, in an example of the present invention, a tuneable dispersion compensator is fitted into a BER feedback control scheme. In the preferred embodiment, the tuneable dispersion compensator is of the type described above with reference to FIGS. 1 and 2.

In an optical transmission system 30, incoming data is processed by an FEC encoder 31 and then a transmitter 32 modulates this pre-coded data onto an optical carrier. Typically the optical transmission system is a WDM system containing a number of individual transmitter and receiver pairs, whereby each pair has its own individual tuneable dispersion compensation element. For the sake of description only a single wavelength is considered. The optical data signal enters an optical transmission line 33 which is typically made up of a concatenation of optical booster amplifiers 34 interconnected via significant lengths of optical fibre 35. The net received signal will be subject to dispersion distortion imparted by the optical fibre 35 which effectively linearly delays or advances the signals spectral components with increasing wavelength—that is to say, depending on the sign of the dispersion imparted. A tuneable etalon dispersion compensator 36 is controlled using BER feedback to subsequently impart an opposite sign of dispersion to cancel that of the transmission system. Finally, a receiver 37 demodulates the optical signal and is followed by an FEC decoder 38 which detects and aims to correct transmission errors. By use of the FEC error detection mechanism, dispersion compensator control parameters, for example etalon temperature, may be optimally adjusted via a control setting circuit 39 to achieve a minimum BER. It is possible that in some circumstances a tuneable optical dispersion compensator may be additionally required at the transmitter end to enable a form of dispersive pre-distortion to be applied for enhanced transmission performance (not shown). For the specific control of the etalon temperatures it is normal to use either heaters or more preferably thermoelectric coolers (TEC) which may be driven by a control current. Such devices are typically integrated into the component together with a form of temperature measurement based on thermocouples, thermistors or resistive temperature devices.

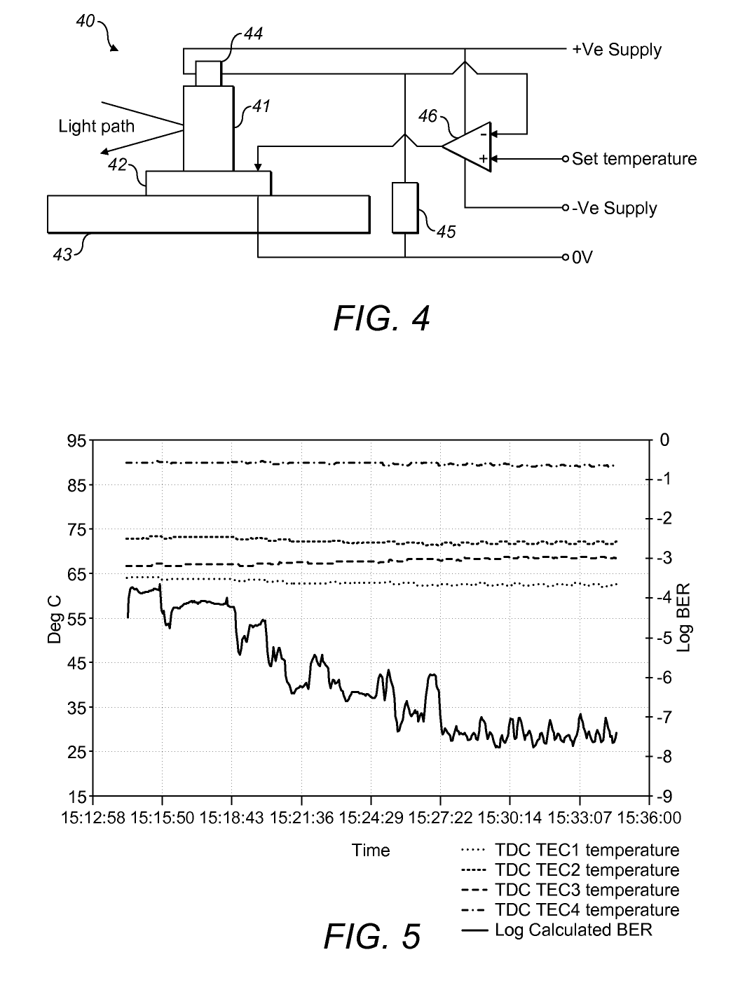

A simplified example of a tuneable etalon device 40 is shown in FIG. 4. An etalon 41 is mounted in thermal contact with a TEC 42 which in turn is in contact with a heatsink 43. The temperature of the etalon 41 is monitored via a resistive thermistor 44 that changes its resistance as a function of temperature. The thermistor 44 is connected in series with a nominal value resistor 45 across the terminals of a power supply, effectively creating a potential divider providing a measure of temperature in terms of a variable voltage at the resistor-thermistor interface. An external BER control algorithm (discussed below) is used to derive a set temperature voltage and the difference between this voltage and the thermistor derived temperature voltage is deemed the error voltage. As will be discussed below, the set temperature voltage is one predicted by the calibration data initially and subsequently modified by a FEC BER feedback control algorithm.

A power amplifier 46 is used to significantly amplify the error voltage seen between its inputs and this is applied to drive current through the TEC 42. Depending on the sign of the error voltage the direction of the current is reversed causing the TEC 42 to either heat or cool for each respective current direction. The TEC 42 acts as a heat pump and removes thermal energy from one surface and emanates this energy through the opposite surface. Thus the temperature of the etalon 41 may be approximately stabilized given environmental changes and be simply controlled by an adjustment of the set temperature voltage.

In the present invention, the etalon temperatures are not set and maintained according to the detailed calibration data supplied by the manufacturer, which data inherently assumes that a pseudo-linear group delay is required for each desired dispersion setting. Instead, the temperature of each tuneable etalon is initially set according to the dispersion required (based on the supplied calibration data) and is subsequently modified in a continuous or periodic manner using a feedback control loop which allows the individual etalon temperatures to vary outside the supplied calibration settings for the group in order to reduce BER at the receiver and thereby improve transmission performance.

Typically BER is derived from an error counter register at the receiver that may periodically be read and re-set. A simplistic control algorithm may take this error counter reading as a basis of transmission performance. By periodically monitoring this BER and then modifying one of the etalon wavelength offset tuning parameters (such as the etalon temperature), the algorithm can be crafted to try and improve the BER using a classical dither algorithm. For instance:

Start loop:
Increase Etalon Temperature
Wait 1 second
Read errors, calculate BER1
Decrease Etalon Temperature
Wait 1 second
Read errors, calculate BER2
IF BER1>BER2 Decrease Etalon Temperature
IF BER1<BER2 Increase Etalon Temperature
.....
Repeat above for other Etalons
....
Repeat loop

In the above example, the etalon temperature is adjusted for each individual etalon in the concatenated series in a sequential manner to achieve an on-going optimisation of the BER performance. In an alternative arrangement, the etalon temperatures, or other control parameters, may be adjusted in parallel by use of more sophisticated algorithms such as the “Nelder-Mead simplex algorithm”.

FIG. 5 illustrates an example of how the control algorithm described above is effective to converge with time, thereby improving the BER. The control loop is started with the supplied calibration data and the final optimised etalon temperatures are typically not the same as the calibration prediction. Indeed, more complex non-linear group delay profiles are automatically discovered by the control algorithm. Such profiles would be difficult to predict via pre-calibration.

The scheme is adaptive and can compensate for system ageing or repair, and environmental temperature effects on the equipment or transmission fibre.

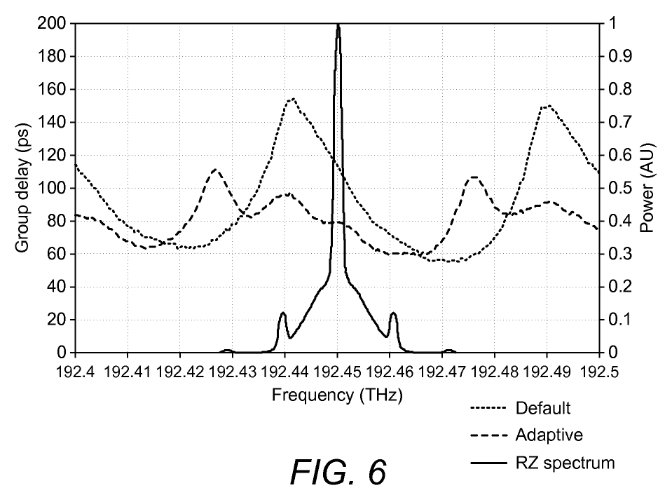

As shown in FIG. 6, the power spectral density of an RZ (return to zero) signal shown is highest at low frequencies and lowest at high frequencies with respect to the carrier. Dispersion offers least penalty to low frequency components and most to high frequency components. It is found that the control algorithm tends to ignore these two areas of the spectrum, instead deriving a more complex shape around the mid spectral components which are more important. The effective operating bandwidth of the component is increased to some extent by removing the constraint of a linear group delay requirement. With a device designed for NRZ (non return to zero) at 10 Gb/s it is possible to achieve satisfactory performance with CRZ (chirped RZ) at the same bit rate. In contrast, by using calibration data provided by the manufacturer the RZ and CRZ performance is degraded.

Although the example described above is based upon a tuneable etalon device, the present invention can also be used with other tuneable dispersion compensators such as waveguide Mach Zehnder interferometers and micro-rings. In a micro-ring device, which is fabricated on a waveguide substrate (eg. silica glass on silicon), miniature waveguide rings are closely coupled to a signal waveguide. The micro-rings effectively resonate with a repeating wavelength characteristic that is similar to an all-pass etalon with the circumference substantially setting the repeat period. By adjusting the localised temperature of the micro-ring, with a heater for example, again the expansion coefficient may be utilised to minutely alter the ring circumference and this will in turn be reflected as a slight wavelength movement of the group delay characteristic. The depth of the Lorentzian-like group delay characteristic is a characteristic of the coupling distance between the transmission waveguide and the ring, stronger coupling leading to a stronger response. Thus several concatenated micro-rings with appropriate coupling factors can be tuned to a quasi-linear group delay response in exactly the same way as a group of all-pass etalons.

The above example uses a FEC BER feedback control algorithm. However, alternative measures of received signal quality could be used instead of BER. For example, it is possible to detect a rectified peak RF voltage of an optical signal and adjust the dispersion control settings using feedback to maximise this detected RF voltage. This is useful for RZ signals which give rise to a pulse with a clearly defined (sharp) peak when the dispersion compensation is optimised.

1. A method of controlling a tuneable optical dispersion compensating device to act on an optical signal by automatically controlling a plurality of dispersion control settings of the device in a systematic way using feedback, thereby to adapt freely the optical group delay for the optical signal within a predetermined wavelength range including that of the optical signal.

2. A method according to claim 1, in which the tuneable optical dispersion compensating device is a concatenated series of optical all-pass filters.

3. A method according to claim 1, in which the tuneable optical dispersion compensating device is a concatenated series of etalon filters.

4. A method according to claim 3, in which the dispersion control settings are the etalon temperature for each respective etalon filter.

5. A method according to claim 4, comprising an initial step of selecting an etalon temperature for each etalon based on a required dispersion, using standard calibration data for the device.

6. A method according to any of claims 3, in which the etalon filters are tuned to act over a specific wavelength range including that of the optical signal to be compensated.

7. A method according to claim 1, in which the dispersion control settings control temperature to tune the dispersion compensation.

8. A method according to claim 7, in which the tuneable optical dispersion compensating device is a micro-ring device.

9. A method according to claim 1, in which the tuneable optical dispersion compensation device is a waveguide Mach Zehnder interferometer device.

10. A method according to claim 1, in which the dispersion control settings are controlled in dependence on a measure of received optical signal quality.

11. A method according to claim 1, in which the dispersion control settings are controlled in dependence on bit error rate (BER) measured at a receiver.

12. A method according to claim 1, in which the dispersion control settings are varied sequentially.

13. A method according to claim 12, in which a dither algorithm is used to adjust the dispersion control settings.

14. A method according to claim 1, in which the dispersion control settings are varied in parallel.

15. A method according to claim 14, in which the dispersion control parameters are adjusted in parallel by use of a “Nelder-Mead simplex” algorithm.

16. A tuneable optical dispersion compensating device comprising a concatenated series of tuneable all-pass filters and a feedback control circuit coupled to each of the tuneable all-pass filters for automatically controlling one or more dispersion control settings for each tuneable all-pass filter in a systematic way, thereby to adapt freely the optical group delay for a received optical signal within a predetermined wavelength range including that of the optical signal.

17. A tuneable optical dispersion compensating device according to claim 16, in which the all-pass filters are etalon filters.

18. A tuneable optical dispersion compensating device according to claim 16, in which the all-pass filters are waveguide Mach Zehnder interferometers.

19. A tuneable optical dispersion compensating device according to claim 16, in which the all-pass filters are micro-ring devices.

20. A tuneable optical dispersion compensating device according to claim 16, in which the feedback control circuit controls the dispersion control settings in dependence on a measure of received signal quality.

21. A tuneable optical dispersion compensating device according to claim 16, in which the feedback control circuit controls the dispersion control settings in dependence on a measure of bit error rate (BER).
